(19) United States
(12) Patent Application Publication
(10) Pub. No.: US 2024/0202866 A1
(43) Pub. Date: Jun. 20, 2024

(54) Warped Perspective Correction

(71) Applicant: Apple Inc., Cupertino, CA (US)

(72) Inventors: Samer Barakat, Elk Grove, CA (US); Bertrand Nepveu, Montreal (CA); Christian W. Gosch, Campbell, CA (US); Emmanuel Piuze-Phaneuf, Los Gatos, CA (US); Vincent Chapdelaine-Couture, Carignan (CA)

(21) Appl. No.: 18/286,522

(22) PCT Filed: Mar. 29, 2022
(86) PCT No.: PCT/US22/22280

§ 371 Date: Oct. 11, 2023

Related U.S. Application Data
(60) Provisional application No. 63/173,640, filed on Apr. 12, 2021.

(51) Int. Cl. G06T 3/18; G02B 27/01; G06T 7/55

(52) U.S. Cl. CPC G06T 3/18; G02B 27/017; G06T 7/55

(57) ABSTRACT

In one implementation, a method of performing perspective correction of an image is performed by a device including an image sensor, a display, one or more processors, and non-transitory memory. The method includes capturing, using the image sensor, an image of a physical environment. The method includes obtaining a plurality of initial depths respectively associated with a plurality of pixels of the image of the physical environment. The method includes generating a depth map for the image of the physical environment based on the plurality of initial depths and a respective plurality of confidences of the plurality of initial depths. The method includes transforming, using the one or more processors, the image of the physical environment based on the depth map and a difference between a perspective of the image sensor and a perspective of a user. The method includes displaying, on the display, the transformed image.

### CROSS-REFERENCE TO RELATED APPLICATIONS

This application claims priority to U.S. Provisional Patent App. No. 63/173,640, filed on Apr. 12, 2021, which is hereby incorporated by reference in its entirety.

### TECHNICAL FIELD

The present disclosure generally relates to systems, methods, and devices for correcting a difference between a perspective of an image sensor and a perspective of a user in a physical environment.

### BACKGROUND

In various implementations, an extended reality (XR) environment is presented by a head-mounted device (HMD). Various HMDs include a scene camera that captures an image of the physical environment in which the user is present (e.g., a scene) and a display that displays the image to the user. In some instances, this image or portions thereof can be combined with one or more virtual objects to present the user with an XR experience. In other instances, the HMD can operate in a pass-through mode in which the image or portions thereof are presented to the user without the addition of virtual objects. Ideally, the image of the physical environment presented to the user is substantially similar to what the user would see if the HMD were not present. However, due to the different positions of the eyes, the display, and the camera in space, this may not occur, resulting in impaired distance perception, disorientation, and poor hand-eye coordination.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIG. 1 is a block diagram of an example operating environment in accordance with some implementations.

FIG. 2 is a block diagram of an example controller in accordance with some implementations.

FIG. 3 is a block diagram of an example electronic device in accordance with some implementations.

FIG. 4 illustrates an example scenario related to capturing an image of physical environment and displaying the captured image in accordance with some implementations.

FIG. 5 is an image of physical environment captured by an image sensor from a particular perspective.

FIG. 6 is an overhead perspective view of the physical environment of FIG. 5.

FIG. 7A illustrates a first image of the physical environment of FIG. 5 captured by a left image sensor.

FIG. 7B illustrates a view of the physical environment of FIG. 5 as would be seen by a left eye of a user if the user were not wearing an HMD.

FIGS. 8A-8D illustrate levels of a quadtree.

FIG. 9 is a flowchart representation of a method of performing a perspective transform of an image in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### SUMMARY

Various implementations disclosed herein include devices, systems, and methods for performing perspective correction of an image. In various implementations, the method is performed by a device including an image sensor, a display, one or more processors, and non-transitory memory. The method includes capturing, using the image sensor, an image of a physical environment. The method includes obtaining a plurality of initial depths respectively associated with a plurality of pixels of the image of the physical environment. The method includes generating a depth map for the image of the physical environment based on the plurality of initial depths and a respective plurality of confidences of the plurality of initial depths. The method includes transforming, using the one or more processors, the image of the physical environment based on the depth map and a difference between a perspective of the image sensor and a perspective of a user. The method includes displaying, on the display, the transformed image.

In accordance with some implementations, a device includes one or more processors, a non-transitory memory, and one or more programs; the one or more programs are stored in the non-transitory memory and configured to be executed by the one or more processors. The one or more programs include instructions for performing or causing performance of any of the methods described herein. In accordance with some implementations, a non-transitory computer readable storage medium has stored therein instructions, which, when executed by one or more processors of a device, cause the device to perform or cause performance of any of the methods described herein. In accordance with some implementations, a device includes: one or more processors, a non-transitory memory, and means for performing or causing performance of any of the methods described herein.

### DESCRIPTION

People may sense or interact with a physical environment or world without using an electronic device. Physical features, such as a physical object or surface, may be included within a physical environment. For instance, a physical environment may correspond to a physical city having physical buildings, roads, and vehicles. People may directly sense or interact with a physical environment through various means, such as smell, sight, taste, hearing, and touch. This can be in contrast to an extended reality (XR) environment that may refer to a partially or wholly simulated environment that people may sense or interact with using an electronic device. The XR environment may include virtual reality (VR) content, mixed reality (MR) content, augmented reality (AR) content, or the like. Using an XR system, a portion of a person's physical motions, or representations thereof, may be tracked and, in response, properties of virtual objects in the XR environment may be changed in a way that complies with at least one law of nature. For example, the XR system may detect a user's head movement and adjust auditory and graphical content presented to the user in a way that simulates how sounds and views would change in a physical environment. In other examples, the XR system may detect movement of an electronic device (e.g., a laptop, tablet, mobile phone, or the like) presenting the XR environment. Accordingly, the XR system may adjust auditory and graphical content presented to the user in a way that simulates how sounds and views would change in a physical environment. In some instances, other inputs, such as a representation of physical motion (e.g., a voice command), may cause the XR system to adjust properties of graphical content.

Numerous types of electronic systems may allow a user to sense or interact with an XR environment. A non-exhaustive list of examples includes lenses having integrated display capability to be placed on a user's eyes (e.g., contact lenses), heads-up displays (HUDs), projection-based systems, head mountable systems, windows or windshields having integrated display technology, headphones/earphones, input systems with or without haptic feedback (e.g., handheld or wearable controllers), smartphones, tablets, desktop/laptop computers, and speaker arrays. Head mountable systems may include an opaque display and one or more speakers. Other head mountable systems may be configured to receive an opaque external display, such as that of a smartphone. Head mountable systems may capture images/video of the physical environment using one or more image sensors or capture audio of the physical environment using one or more microphones. Instead of an opaque display, some head mountable systems may include a transparent or translucent display. Transparent or translucent displays may direct light representative of images to a user's eyes through a medium, such as a hologram medium, optical waveguide, an optical combiner, optical reflector, other similar technologies, or combinations thereof. Various display technologies, such as liquid crystal on silicon, LEDs, uLEDs, OLEDs, laser scanning light source, digital light projection, or combinations thereof, may be used. In some examples, the transparent or translucent display may be selectively controlled to become opaque. Projection-based systems may utilize retinal projection technology that projects images onto a user's retina or may project virtual content into the physical environment, such as onto a physical surface or as a hologram.

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices, and circuits have not been described in exhaustive detail so as not to obscure more pertinent aspects of the example implementations described herein.

As described above, in an HMD with a display and a scene camera, the image of the real world presented to the user on the display may not always reflect what the user would see if the HMD were not present due to the different positions of the eyes, the display, and the camera in space. In various circumstances, this results in poor distance perception, disorientation of the user, and poor hand-eye coordination, e.g., while interacting with the physical environment.

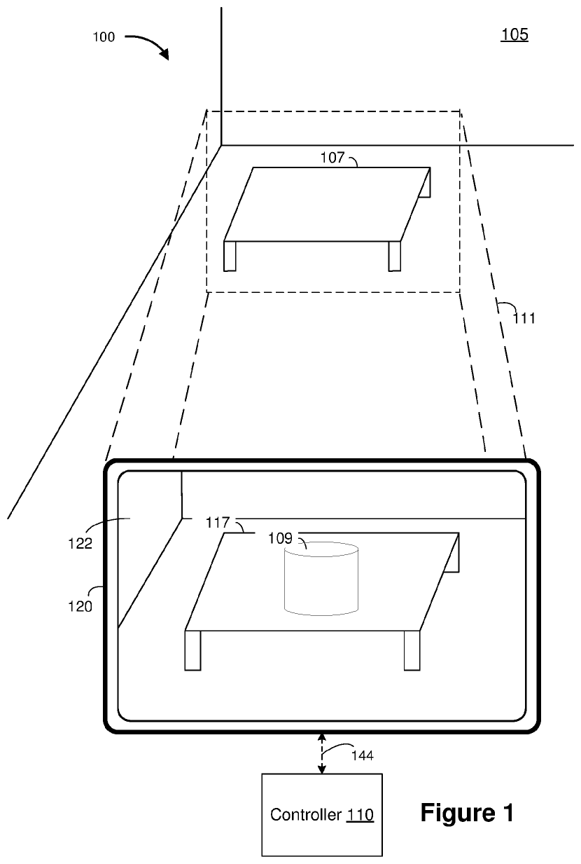

FIG. 1 is a block diagram of an example operating environment 100 in accordance with some implementations. While pertinent features are shown, those of ordinary skill in the art will appreciate from the present disclosure that various other features have not been illustrated for the sake of brevity and so as not to obscure more pertinent aspects of the example implementations disclosed herein. To that end, as a non-limiting example, the operating environment 100 includes a controller 110 and an electronic device 120.

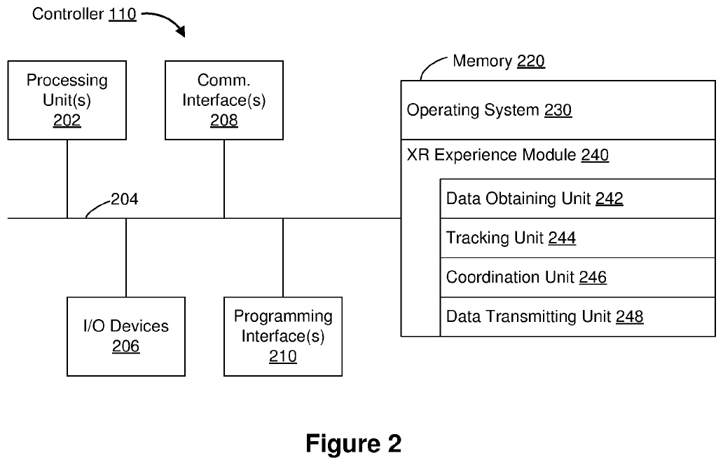

In some implementations, the controller 110 is configured to manage and coordinate an XR experience for the user. In some implementations, the controller 110 includes a suitable combination of software, firmware, and/or hardware. The controller 110 is described in greater detail below with respect to FIG. 2. In some implementations, the controller 110 is a computing device that is local or remote relative to the physical environment 105. For example, the controller 110 is a local server located within the physical environment 105. In another example, the controller 110 is a remote server located outside of the physical environment 105 (e.g., a cloud server, central server, etc.). In some implementations, the controller 110 is communicatively coupled with the electronic device 120 via one or more wired or wireless communication channels 144 (e.g., BLUETOOTH, IEEE 802.11x, IEEE 802.16x, IEEE 802.3x, etc.). In another example, the controller 110 is included within the enclosure of the electronic device 120. In some implementations, the functionalities of the controller 110 are provided by and/or combined with the electronic device 120.

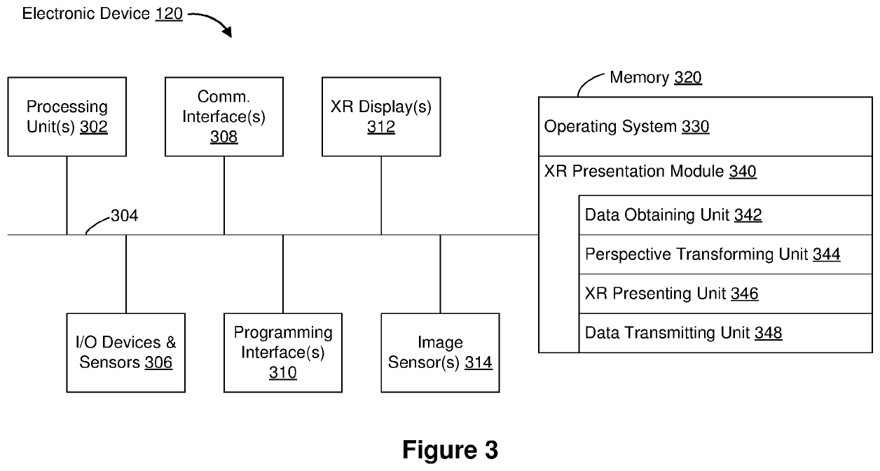

In some implementations, the electronic device 120 is configured to provide the XR experience to the user. In some implementations, the electronic device 120 includes a suitable combination of software, firmware, and/or hardware. According to some implementations, the electronic device 120 presents, via a display 122, XR content to the user while the user is physically present within the physical environment 105 that includes a table 107 within the field-of-view 111 of the electronic device 120. As such, in some implementations, the user holds the electronic device 120 in his/her hand(s). In some implementations, while providing XR content, the electronic device 120 is configured to display an XR object (e.g., an XR cylinder 109) and to enable video pass-through of the physical environment 105 (e.g., including a representation 117 of the table 107) on a display 122. The electronic device 120 is described in greater detail below with respect to FIG. 3.

According to some implementations, the electronic device 120 provides an XR experience to the user while the user is virtually and/or physically present within the physical environment 105.

In some implementations, the user wears the electronic device 120 on his/her head. For example, in some implementations, the electronic device includes a head-mounted system (HMS), head-mounted device (HMD), or head-mounted enclosure (HME). As such, the electronic device 120 includes one or more XR displays provided to display the XR content. For example, in various implementations, the electronic device 120 encloses the field-of-view of the user. In some implementations, the electronic device 120 is a handheld device (such as a smartphone or tablet) configured to present XR content, and rather than wearing the electronic device 120, the user holds the device with a display directed towards the field-of-view of the user and a camera directed towards the physical environment 105. In some implementations, the handheld device can be placed within an enclosure that can be worn on the head of the user. In some implementations, the electronic device 120 is replaced with an XR chamber, enclosure, or room configured to present XR content in which the user does not wear or hold the electronic device 120.

FIG. 2 is a block diagram of an example of the controller 110 in accordance with some implementations. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the controller 110 includes one or more processing units 202 (e.g., microprocessors, application-specific integrated-circuits (ASICs), field-programmable gate arrays (FPGAs), graphics processing units (GPUs), central processing units (CPUs), processing cores, and/or the like), one or more input/output (I/O) devices 206, one or more communication interfaces 208 (e.g., universal serial bus (USB), FIREWIRE, THUNDERBOLT, IEEE 802.3x, IEEE 802.11x, IEEE 802.16x, global system for mobile communications (GSM), code division multiple access (CDMA), time division multiple access (TDMA), global positioning system (GPS), infrared (IR), BLUETOOTH, ZIGBEE, and/or the like type interface), one or more programming (e.g., I/O) interfaces 210, a memory 220, and one or more communication buses 204 for interconnecting these and various other components.

In some implementations, the one or more communication buses 204 include circuitry that interconnects and controls communications between system components. In some implementations, the one or more I/O devices 206 include at least one of a keyboard, a mouse, a touchpad, a joystick, one or more microphones, one or more speakers, one or more image sensors, one or more displays, and/or the like.

The memory 220 includes high-speed random-access memory, such as dynamic random-access memory (DRAM), static random-access memory (SRAM), double-data-rate random-access memory (DDR RAM), or other random-access solid-state memory devices. In some implementations, the memory 220 includes non-volatile memory, such as one or more magnetic disk storage devices, optical disk storage devices, flash memory devices, or other non-volatile solid-state storage devices. The memory 220 optionally includes one or more storage devices remotely located from the one or more processing units 202. The memory 220 comprises a non-transitory computer readable storage medium. In some implementations, the memory 220 or the non-transitory computer readable storage medium of the memory 220 stores the following programs, modules and data structures, or a subset thereof including an optional operating system 230 and an XR experience module 240.

The operating system 230 includes procedures for handling various basic system services and for performing hardware dependent tasks. In some implementations, the XR experience module 240 is configured to manage and coordinate one or more XR experiences for one or more users (e.g., a single XR experience for one or more users, or multiple XR experiences for respective groups of one or more users). To that end, in various implementations, the XR experience module 240 includes a data obtaining unit 242, a tracking unit 244, a coordination unit 246, and a data transmitting unit 248.

In some implementations, the data obtaining unit 242 is configured to obtain data (e.g., presentation data, interaction data, sensor data, location data, etc.) from at least the electronic device 120 of FIG. 1. To that end, in various implementations, the data obtaining unit 242 includes instructions and/or logic therefor, and heuristics and metadata therefor.

In some implementations, the tracking unit 244 is configured to map the physical environment 105 and to track the position/location of at least the electronic device 120 with respect to the physical environment 105 of FIG. 1. To that end, in various implementations, the tracking unit 244 includes instructions and/or logic therefor, and heuristics and metadata therefor.

In some implementations, the coordination unit 246 is configured to manage and coordinate the XR experience presented to the user by the electronic device 120. To that end, in various implementations, the coordination unit 246 includes instructions and/or logic therefor, and heuristics and metadata therefor.

In some implementations, the data transmitting unit 248 is configured to transmit data (e.g., presentation data, location data, etc.) to at least the electronic device 120. To that end, in various implementations, the data transmitting unit 248 includes instructions and/or logic therefor, and heuristics and metadata therefor.

Although the data obtaining unit 242, the tracking unit 244, the coordination unit 246, and the data transmitting unit 248 are shown as residing on a single device (e.g., the controller 110), it should be understood that in other implementations, any combination of the data obtaining unit 242, the tracking unit 244, the coordination unit 246, and the data transmitting unit 248 may be located in separate computing devices.

Moreover, FIG. 2 is intended more as functional description of the various features that may be present in a particular implementation as opposed to a structural schematic of the implementations described herein. As recognized by those of ordinary skill in the art, items shown separately could be combined and some items could be separated. For example, some functional modules shown separately in FIG. 2 could be implemented in a single module and the various functions of single functional blocks could be implemented by one or more functional blocks in various implementations. The actual number of modules and the division of particular functions and how features are allocated among them will vary from one implementation to another and, in some implementations, depends in part on the particular combination of hardware, software, and/or firmware chosen for a particular implementation.

FIG. 3 is a block diagram of an example of the electronic device 120 in accordance with some implementations. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the electronic device 120 includes one or more processing units 302 (e.g., microprocessors, ASICs, FPGAs, GPUs, CPUs, processing cores, and/or the like), one or more input/output (I/O) devices and sensors 306, one or more communication interfaces 308 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, and/or the like type interface), one or more programming (e.g., I/O) interfaces 310, one or more XR displays 312, one or more optional interior- and/or exterior-facing image sensors 314, a memory 320, and one or more communication buses 304 for interconnecting these and various other components.

In some implementations, the one or more communication buses 304 include circuitry that interconnects and controls communications between system components. In some implementations, the one or more I/O devices and sensors 306 include at least one of an inertial measurement unit (IMU), an accelerometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some implementations, the one or more XR displays 312 are configured to provide the XR experience to the user. In some implementations, the one or more XR displays 312 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electro-mechanical system (MEMS), and/or the like display types. In some implementations, the one or more XR displays 312 correspond to diffractive, reflective, polarized, holographic, etc. waveguide displays. For example, the electronic device 120 includes a single XR display. In another example, the electronic device includes an XR display for each eye of the user. In some implementations, the one or more XR displays 312 are capable of presenting MR and VR content.

In some implementations, the one or more image sensors 314 are configured to obtain image data that corresponds to at least a portion of the face of the user that includes the eyes of the user (any may be referred to as an eye-tracking camera). In some implementations, the one or more image sensors 314 are configured to be forward-facing so as to obtain image data that corresponds to the physical environment as would be viewed by the user if the electronic device 120 was not present (and may be referred to as a scene camera). The one or more optional image sensors 314 can include one or more RGB cameras (e.g., with a complimentary metal-oxide-semiconductor (CMOS) image sensor or a charge-coupled device (CCD) image sensor), one or more infrared (IR) cameras, one or more event-based cameras, and/or the like.

The memory 320 includes high-speed random-access memory, such as DRAM, SRAM, DDR RAM, or other random-access solid-state memory devices. In some implementations, the memory 320 includes non-volatile memory, such as one or more magnetic disk storage devices, optical disk storage devices, flash memory devices, or other non-volatile solid-state storage devices. The memory 320 optionally includes one or more storage devices remotely located from the one or more processing units 302. The memory 320 comprises a non-transitory computer readable storage medium. In some implementations, the memory 320 or the non-transitory computer readable storage medium of the memory 320 stores the following programs, modules and data structures, or a subset thereof including an optional operating system 330 and an XR presentation module 340.

The operating system 330 includes procedures for handling various basic system services and for performing hardware dependent tasks. In some implementations, the XR presentation module 340 is configured to present XR content to the user via the one or more XR displays 312. To that end, in various implementations, the XR presentation module 340 includes a data obtaining unit 342, a perspective transforming unit 344, an XR presenting unit 346, and a data transmitting unit 348.

In some implementations, the data obtaining unit 342 is configured to obtain data (e.g., presentation data, interaction data, sensor data, location data, etc.) from at least the controller 110 of FIG. 1. To that end, in various implementations, the data obtaining unit 342 includes instructions and/or logic therefor, and heuristics and metadata therefor.

In some implementations, the perspective transforming unit 344 is configured to transform an image (e.g., from one or more image sensors 314) from a first perspective to a second perspective. To that end, in various implementations, the perspective transforming unit 344 includes instructions and/or logic therefor, and heuristics and metadata therefor.

In some implementations, the XR presenting unit 346 is configured to display the transformed image via the one or more XR displays 312. To that end, in various implementations, the XR presenting unit 346 includes instructions and/or logic therefor, and heuristics and metadata therefor.

In some implementations, the data transmitting unit 348 is configured to transmit data (e.g., presentation data, location data, etc.) to at least the controller 110. In some implementations, the data transmitting unit 348 is configured to transmit authentication credentials to the electronic device. To that end, in various implementations, the data transmitting unit 348 includes instructions and/or logic therefor, and heuristics and metadata therefor.

Although the data obtaining unit 342, the perspective transforming unit 344, the XR presenting unit 346, and the data transmitting unit 348 are shown as residing on a single device (e.g., the electronic device 120), it should be understood that in other implementations, any combination of the data obtaining unit 342, the perspective transforming unit 344, the XR presenting unit 346, and the data transmitting unit 348 may be located in separate computing devices.

Moreover, FIG. 3 is intended more as a functional description of the various features that could be present in a particular implementation as opposed to a structural schematic of the implementations described herein. As recognized by those of ordinary skill in the art, items shown separately could be combined and some items could be separated. For example, some functional modules shown separately in FIG. 3 could be implemented in a single module and the various functions of single functional blocks could be implemented by one or more functional blocks in various implementations. The actual number of modules and the division of particular functions and how features are allocated among them will vary from one implementation to another and, in some implementations, depends in part on the particular combination of hardware, software, and/or firmware chosen for a particular implementation.

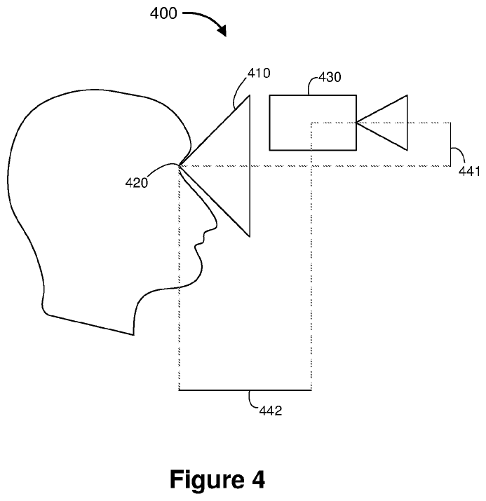

FIG. 4 illustrates an example scenario 400 related to capturing an image of an environment and displaying the captured image in accordance with some implementations. A user wears a device (e.g., the electronic device 120 of FIG. 3) including a display 410 and an image sensor 430. The image sensor 430 captures an image of a physical environment and the display 410 displays the image of the physical environment to the eyes 420 of the user. The image sensor 430 has a perspective that is offset vertically from the perspective of the user (e.g., where the eyes 420 of the user are located) by a vertical offset 441. Further, the perspective of the image sensor 430 is offset longitudinally from the perspective of the user by a longitudinal offset 442. Further, in various implementations, the perspective of the image sensor 430 is offset laterally from the perspective of the user by a lateral offset (e.g., into or out of the page in FIG. 4).

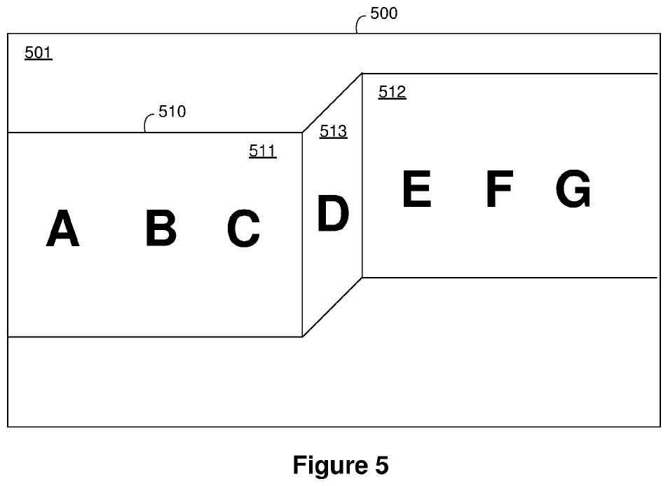

FIG. 5 is an image 500 of a physical environment 501 captured by an image sensor from a particular perspective. The physical environment 501 includes a structure 510 having a first surface 511 nearer to the image sensor, a second surface 512 further from the image sensor, and a third surface 513 connecting the first surface 511 and the second surface 512. The first surface 511 has the letters A, B, and C painted thereon, the third surface 513 has the letter D painted thereon, and the second surface 512 has the letters E, F, and G painted thereon.

From the particular perspective, the image 500 includes all of the letters painted on the structure 510. However, from other perspectives, as described below, a captured image may not include all the letters painted on the structure 510.

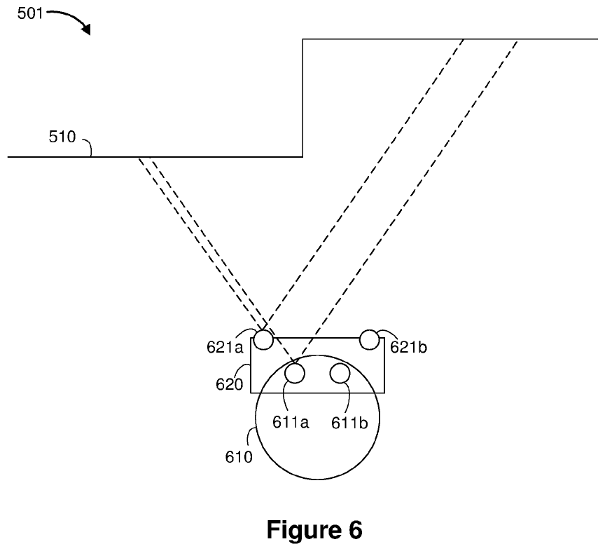

FIG. 6 is an overhead perspective view of the physical environment 501 of FIG. 5. The physical environment 501 includes the structure 510 and a user 610 wearing an HMD 620. The user 610 has a left eye 611a at a left eye location providing a left eye perspective. The user 610 has a right eye 611b at a right eye location providing a right eye perspective. The HMD 620 includes a left image sensor 621a at a left image sensor location providing a left image sensor perspective. The HMD 620 includes a right image sensor 621b at a right image sensor location providing a right image sensor perspective. Because the left eye 611a of the user 610 and the left image sensor 621a of the HMD 620 are at different locations, they each provide different perspectives of the physical environment.

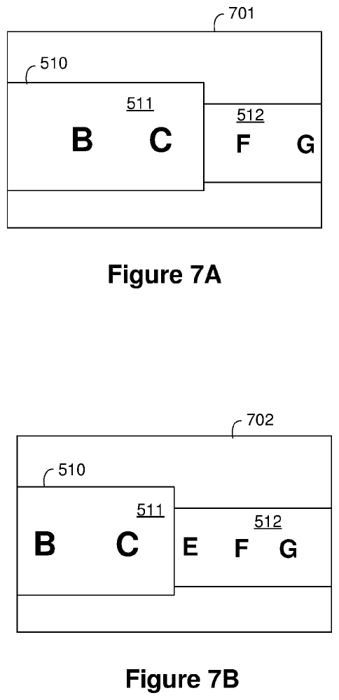

FIG. 7A illustrates a first image 701 of the physical environment 501 captured by the left image sensor 621a. In the first image 701, the first surface 511 of the structure 510 and the second surface 512 of the structure 510 are present. The third surface 513 of the structure cannot be seen in the first image 701. On the first surface 511, the letters B and C can be seen, whereas the letter A is not in the field-of-view of the left image sensor 621a. Similarly, on the second surface 512, the letters F and G can be seen, whereas the letter E is not in the field-of-view of the left image sensor 621a.

FIG. 7B illustrates a view 702 of the physical environment 501 as would be seen by the left eye 611a of the user 610 if the user 610 were not wearing the HMD 620. In the view 702, like the first image 701, the first surface 511 and the second surface 512 are present, but the third surface 513 is not. On the first surface 511, the letters B and C can be seen, whereas the letter A is not in the field-of-view of the left eye 611a. Similarly, on the second surface 512, the letters E, F, and G can be seen. Notably, in the view 702, as compared to the first image 701, the letter E is present on the second surface 512. Thus, the letter E is in the field-of-view of the left eye 611a, but not in the field-of-view of the left image sensor 621a.

In various implementations, the HMD 620 transforms the first image 701 to make it appear as though it was captured from the left eye perspective rather than the left image sensor perspective. In various implementations, the HMD 620 transforms the first image 701 based on the first image 701 and depth values associated with first image 701. In various implementations, depth values are obtained from various sources and have various resolutions and accuracies.

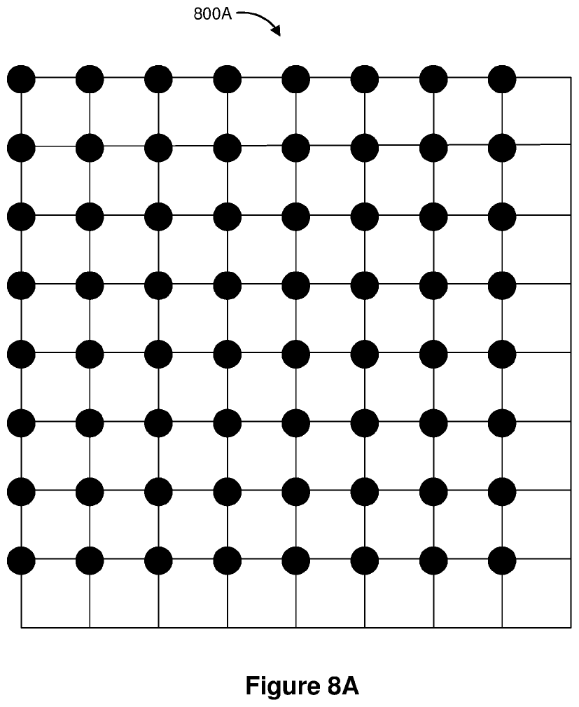

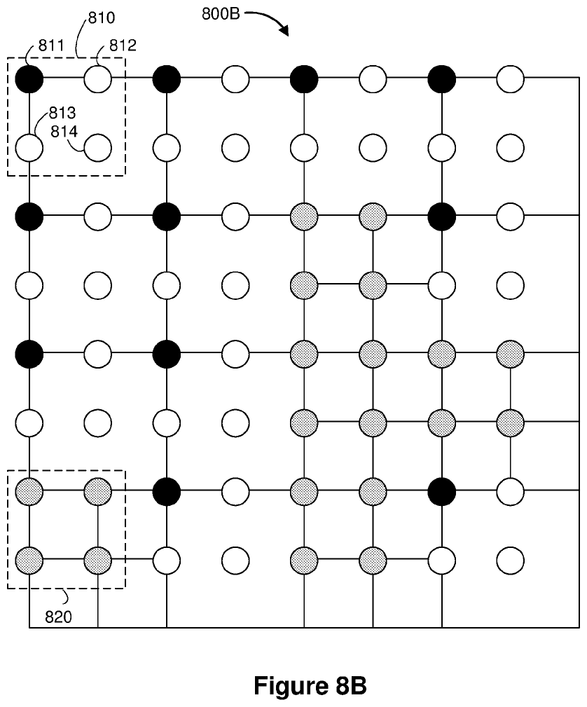

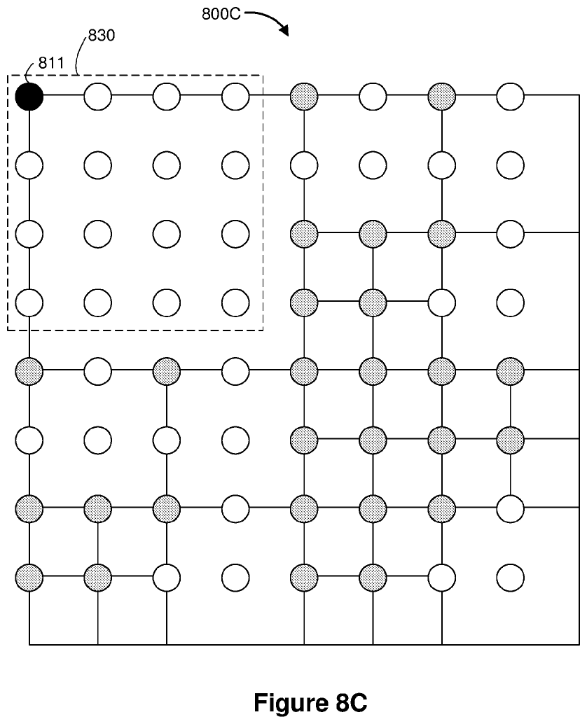

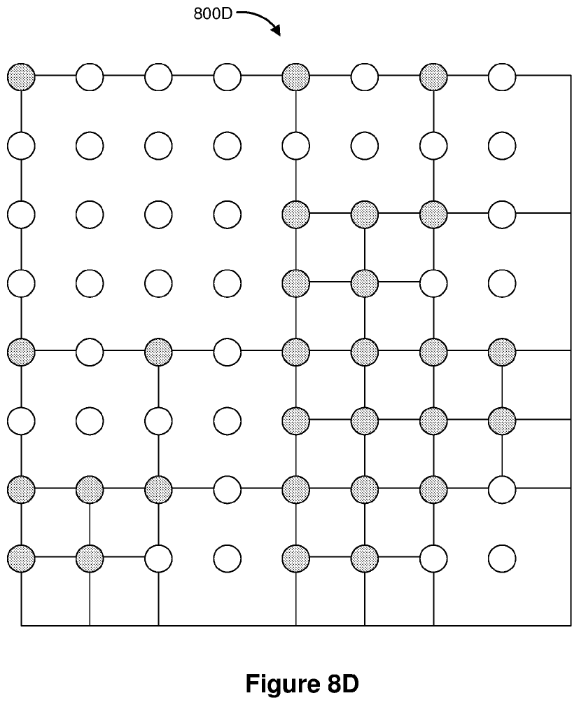

FIG. 8A illustrates an initial grid 800A (or level-0 grid) including an X×Y matrix of nodes. Each node, N(x,y), is associated with a depth value, D(x,y), and a confidence value, C(x,y). In various implementations, the depth values are non-negative real numbers and the confidence values are real numbers ranging from zero to one, with zero indicating no confidence in the corresponding depth value and one indicating complete confidence in the corresponding depth value.

Further, each node is associated with a level value, L(x,y), and a node type, T(x,y). In various implementations, the level values are non-negative integers and the node types are either “Leaf”, “Internal”, or “Merged”. In various implementations, the level value of each node in the initial grid 800A is zero and is increased with each merging pass through the grid. In various implementations, the node type of each node in the initial grid 800A is “Leaf”. With passes through the grid, the node type is changed to “Merged” if the node can be and is merged or “Internal” is the node cannot be merged. In FIGS. 8A-8D, nodes with the node type of “Leaf” are shown in black, nodes with the node type of “Merged” are shown in white, and nodes with the node type of “Internal” are shown in gray. Accordingly, in FIG. 8A, all of the nodes are shown in black.

Each node is associated with a validity flag, H(x,y) based on the confidence values. In various implementations, the validity flag is either a one (or other indication that the corresponding depth value is valid) or a zero (or other indication that the corresponding depth value is invalid). In various implementations, the validity flag for a particular node is set to zero if the confidence value of the particular node is zero (or below a threshold) and is one otherwise. In various implementations, the validity flag for a particular node is set to zero if the confidence value of any node within a neighborhood of the particular node is zero (or below a threshold) and is one otherwise.

The depth values, D (x,y), may be derived from various sources, such as a depth sensor (e.g., LIDAR), VIO, image analysis, or other sources. Where a sparse set of depths are obtained at various locations, from either a single source or multiple sources, the validity flag for nodes associated with the various locations is set to one and the validity flag for other nodes is set to zero. For example, in various implementations, a set of depths includes a first set of 256 depths in a regular 16×16 pattern from a LIDAR sensor and a second set of 400 initial depths randomly distributed over a 1024×768 grid based on stereo image matching. In various implementations, the initial grid 800A is 1024×768 with 656 nodes having a validity flag of one and 785776 nodes having a validity flag of zero.

FIG. 8B illustrates a level-1 grid 800B based on the initial grid 800A of FIG. 8A. In various implementations, various groups of neighboring nodes are represented by a single node. The single node retains the node type of “Leaf” and the other neighboring nodes are merged into the single node and assigned a node type of “Merged”. Thus, the single node represents the group of neighboring nodes. In various implementations, a group of neighboring nodes are merged into a single node if at least one merging criterion is met. In various implementations, a first merging criterion is met if each of the nodes has a node type of “Leaf” and a validity flag of zero. In various implementations, a second merging criterion is met if each of the nodes has a node type of “Leaf” and the depth values of the neighboring nodes can be determined (within a threshold) based on the depth values of non-merged nodes.

For example, in various implementations, groups of four neighboring nodes are merged into a single node if at least one merging criterion is met. Thus, in various implementations, a particular node, N(x,y), of the level-1 grid 800B represents a group of four neighboring nodes including the particular node, N(x,y), and three neighboring nodes: the neighboring node to the right of the particular node, N(x+1,y) the neighboring node below the particular node, N(x,y+1) and the neighboring node to the right and below the particular node, N(x+1,y+1).

The first merging criterion is met if each of the group of four neighboring nodes has a node type of “Leaf” and a validity flag of zero. The second merging criterion is met if each of the group of four nodes has a node type of “Leaf” and the depth values of the neighboring nodes can be determined (within a threshold) based on the depth values of non-merged nodes. For example, the second merging criterion is met if each of the group of four nodes has a node type of “Leaf” and:

$$\vert \frac{1}{2} ( D ( x , y ) + D ( x + 2 , y ) ) - D ( x + 1 , y ) \vert < τ ; \qquad ( 1 )$$

$$\vert \frac{1}{2} ( D ( x , y ) + D ( x , y + 2 ) ) - D ( x , y + 1 ) \vert < τ ; and \qquad ( 2 )$$

$$\vert \frac{1}{2} ( D ( x , y ) + D ( x + 2 , y + 2 ) ) - D ( x + 1 , y + 1 ) \vert < τ . \qquad ( 3 a )$$

Equation (1) indicates that the neighboring node to the right of the particular node can be interpolated by the particular node and the node two to the right of the particular node. Equation (2) indicates that the neighboring node below the particular node can be interpolated by the particular node at the node two below the particular node. Equation (3a) indicates that the neighboring node to the right and below the particular node can be interpolated by the particular node and the node two to the right and two below the particular node. In various implementations, other interpolation equations may be used to determine if a neighboring node can be interpolated by non-merged nodes, such as:

$$\vert \frac{1}{2} ( D ( x + 1 , y + 2 ) + D ( x + 1 , y ) ) - D ( x + 1 , y + 1 ) \vert < τ ; or \qquad ( 3 b )$$

$$\vert \frac{1}{2} ( D ( x + 2 , y + 1 ) + D ( x , y + 1 ) ) - D ( x + 1 , y + 1 ) \vert < τ ; or \qquad ( 3 c )$$

$$\vert \frac{1}{3} ( D ( x , y ) + D ( x + 2 , y ) + D ( x , y + 2 ) ) - D ( x + 1 , y + 1 ) \vert < τ . \qquad ( 3 d )$$

In the level-1 grid 800B, for each node, if the group of four neighboring nodes including the node is mergeable, the node retains the node type of “Leaf” and the others of the group of four neighboring nodes are assigned the node type of “Merged”. If the group of four neighboring nodes is not mergeable, the node is assigned the node of the “Internal”.

Thus, for example, in the level-1 grid 800B, the four nodes in the upper-left corner 810 are merged, the upper-left node 811 retaining the node type of “Leaf” and the others 812-814 being assigned the node type of “Merged”. Such merging may occur being (1) none of the four nodes are valid or (2) the depth values of the now-“Merged” nodes can be determined (within a threshold) based on the depth values of non-merged nodes, such as the “Leaf” nodes to the right and below the upper-left node.

As another example, in the level-1 grid 800B, the four nodes in the lower-left corner 820 are not merged, each of those four nodes being assigned the node type of “Internal”.

FIG. 8C illustrates a level-2 grid 800C based on the level-1 grid 800B of FIG. 8B. In the level-2 grid 800C, for each node with the node type of “Leaf”, if the group of four neighboring nodes (the nearest neighbors being determined ignoring node types with the node type of “Merged”) including the node is mergeable, the node retains the node type of “Leaf” and the others of the group of four neighboring nodes are assigned the node type of “Merged”. If the group of four neighboring nodes is not mergeable, the node is assigned the node of the “Internal”.

Thus, for example, in the level-2 grid 800C, the sixteen nodes 830 in the upper-left corner (as represented by the four “Leaf” nodes) are merged, the upper-left node 811 retaining the node type of “Leaf” and the others being assigned the node type of “Merged”. As another example, in the level-2 grid 800C, all other nodes are not merged and those previously not assigned the node type of “Merged” are assigned the node type of “Internal”.

FIG. 8D illustrates a level-3 grid 800D based on the level-2 grid 800C of FIG. 8C. In the level-3 grid 800D, for each node with the node type of “Leaf”, if the group of four neighboring nodes (the nearest neighbors being determined ignoring node types with the node type of “Merged”) including the node is mergeable, the node retains the node type of “Leaf” and the others of the group of four neighboring nodes are assigned the node type of “Merged”. If the group of four neighboring nodes is not mergeable, the node is assigned the node of the “Internal”.

Thus, in the level-3 grid 800D, all nodes are either “Internal” or “Merged” indicating that no further merging is possible.

In various implementations, the merging (and generation of higher-level grids) is performed if a termination criterion is met. In various implementations, the termination criterion is met when a fixed number of merging procedures have been performed. In various implementations, the termination criterion is met when the grid includes no “Leaf” nodes (and, therefore, no further merging is possible). In various implementations, the grids 800A-800D form a quadtree structure.

The “Internal” nodes of the highest-level grid of the quadtree structure can be used to efficiently determine depths to be used in warping an image. Given a set of nodes, N(x,y), each having a respective depth value Dₙ(x,y), and a respective confidence value, C(x,y), an updated depth value Dₙ₊₁ (x,y) for each node is determined. For the first iteration, the respective depth values, D₀(x,y), may be derived from various sources, such as a depth sensor (e.g., LIDAR), VIO, image analysis, or other sources. In various implementations, the set of nodes N(x,y) are the “Internal” nodes (or the non-“Merged” nodes) of the highest-level grid of a quadtree structure.

In various implementations, the updated depth value for a particular node is determined to optimize an energy function. In various implementations, the energy function is a function of (1) a data-matching term based on the depth value for the particular node and the confidence value of the node and (2) a smoothness term based on the depth values of nodes within a neighborhood of the particular node and the confidence values of nodes within the neighborhood of the particular node. For example, in various implementations, the energy function is a weighted sum of the data-matching term and the smoothness term. In various implementations, the energy function includes additional terms, such as terms to enforce hardware constraints or color-matching constraints.

In various implementations, the energy function for a particular node, N(x,y), evaluated at a particular depth, d, is:

$$E ( d , x , y ) = \frac{{a}_{d} {E}_{d a t a} ( d , x , y ) + {a}_{s} {E}_{s m o o t h} ( d , x , y )}{{a}_{d} λ ( {E}_{data} ( d , x , y ) ) + {a}_{s} λ ( {E}_{s m o o t h} ( d , x , y ) )} , \qquad ( 4 )$$

where E_{data}(d,x,y) is a data-matching term for node N(x,y), Eₛₘₒₒₜₕ(d,x,y) is a smoothness term for node N(x,y), a_{d} is a weighting factor for the data-matching term, aₛ is a weighting factor for the smoothness term, and the function λ is 0 if the input, e.g., E_{data} or Eₛₘₒₒₜₕ, is zero and is 1 otherwise.

In various implementations, the weighting factor for the data-matching term and the weighting factor for the smoothness term are constants. In various implementations, the weighting factor for the data-matching term is a function of a user's gaze at a location (x_{g}, y_{g}). In various implementations, the weighting factor reduces the data-matching term away from the user's gaze, resulting in more smoothness in these areas. For example, in various implementations:

$${a}_{d} ( x , y ) = {g}_{1} {e}^{- {g}_{2} ( {( x - {x}_{g} )}^{2} + {( y - {y}_{g} )}^{2} )} \qquad ( 5 )$$

wherein g₁ and g₂ are scalar factors referred to, respectively, as a depth weight and a weight decay.

In various implementations, the updated depth value Dₙ₊₁(x,y) for a particular node, N(x,y), is the depth value that maximizes the energy function for the particular node:

$${D}_{n + 1} ( x , y ) = arg {max}_{d} E ( d , x , y ) . \qquad ( 6 )$$

In various implementations, an updated confidence value Cₙ₊₁(x,y) is determined as:

$${C}_{n + 1} ( x , y ) = max ( {E}_{dαta} ( {D}_{n + 1} ( x , y ) , x , y ) , {E}_{s m o o t h} ( {D}_{n + 1} ( x , y ) , x , y ) ) . \qquad ( 7 )$$

In various implementations, the data-matching term and the smoothness term are based on a Gaussian function, Q(r,s,t). In various implementations Q(r,s,t) is defined as follows:

$$Q ( r , s , t ) = t {e}^{- {( f ( r - s ) / r )}^{2}} , \qquad ( 8 )$$

where f is a scaling factor controlling the width of the Gaussian. Thus, the function Q(r,s,t) is a Gaussian having a maximum value of t when r-s and a width proportional to f. In various implementations, f is selected as proportional to t.

For example, in various implementations, the data-matching term is:

$${E}_{data} ( d , x , y ) = Q ( d , {D}_{0} ( x , y ) , {C}_{0} ( x , y ) ) \qquad ( 9 )$$

Thus, in various implementations, the data-matching term is:

$${E}_{data} ( d , x , y ) = {C}_{0} ( x , y ) {e}^{- {( f ( d - {D}_{0} ( x , y ) ) / d )}^{2}} \qquad ( 10 )$$

The data-matching term is a Gaussian having a maximum value of Co(x,y) when d=Dₙ(x,y) and a width proportional to f.

For the smoothness term, a neighborhood of the particular node, N(x,y), is defined as G. In various implementations, the neighborhood, G, includes the particular node and its 4 nearest neighbors upwards, downwards, leftwards, and rightwards. In various implementations, the neighborhood, G, includes the particular node and any nodes within a particular distance of the particular node.

In various implementations, based on the depth and confidence values of the pixels in the neighborhood, G, an interpolated depth, D′(x,y), and interpolated confidence, C′(x,y), are determined using a pixel based interpolation scheme.

Further, a clamped depth, D″(x,y), is determined by setting any D′(x,y) greater than the maximum depth in the neighborhood to that maximum depth and setting any D′(x,y) less than the minimum depth in the neighborhood to that minimum depth. Similarly, a clamped confidence, C″(x,y), is determined by setting any C′(x,y) greater than the maximum confidence in the neighborhood to that maximum confidence and setting any D′(x,y) less than the minimum confidence in the neighborhood to that minimum confidence.

In various implementations, the smoothness term is:

$${E}_{s m o o t h} ( d , x , y ) = \{ \begin{matrix}0 & {C}^{′} ( x , y ) = 0 \\ Q ( d , {D}^{″} ( x , y ) , {C}^{″} ( x , y ) ) & otherwise\end{matrix} . \qquad ( 11 )$$

In various implementations, updated depth values (and confidence values) are determined over a number of iterations. For example, in various implementations, the number of iterations is 16. The final determined depth values are used, to transforms an image from a perspective of the camera to a perspective of the eye of the user.

As noted above, in various implementations, the energy function includes additional terms, such as terms to enforce hardware constraints or color-matching constraints. Where, Eₖ are energy terms mapping a value, d, and a set of input signals, Sₖ, to an energy value, Equation (4) can be generalized as:

$$E ( d , x , y ) = \frac{1}{{\sum }_{k} {a}_{k} λ ( {E}_{k} ( d , {S}_{k} ( x , y ) ) )} {\sum }_{k} {a}_{k} {E}_{k} ( d , {S}_{k} ( x , y ) ) . \qquad ( 12 )$$

Similarly, Equation (7) can be generalized as:

$${C}_{n + 1} ( x , y ) = {max}_{k} {E}_{k} ( {D}_{n + 1} ( x , y ) , {S}_{k} ( x , y ) ) . \qquad ( 13 )$$

In various implementations, the input signals, Sₖ, include RGB color images, depth information, and confidences. In various implementations, the input signals, Sₖ, further define hardware-constraints.

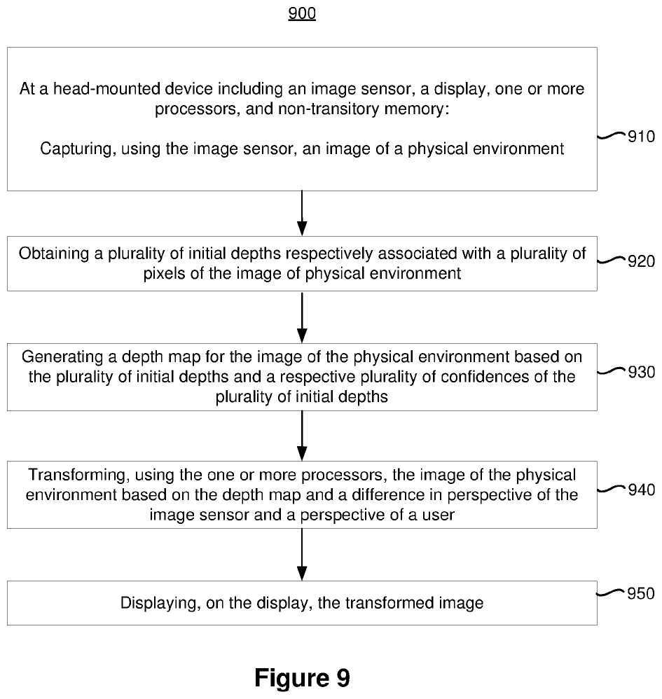

FIG. 9 is a flowchart representation of a method of performing perspective correction of an image in accordance with some implementations. In various implementations, the method 900 is performed by a device with one or more processors, non-transitory memory, an image sensor, and a display (e.g., the electronic device 120 of FIG. 3). In various implementations, the device is a head-mounted device (HMD) and the image sensor is a forward-facing image sensor. In some implementations, the method 900 is performed by processing logic, including hardware, firmware, software, or a combination thereof. In some implementations, the method 900 is performed by a processor executing instructions (e.g., code) stored in a non-transitory computer-readable medium (e.g., a memory).

The method 900 begins, in block 910, with the device capturing, using the image sensor, an image of a physical environment.

The method 900 continues, in block 920, with the device obtaining a plurality of initial depths respectively associated with a plurality of pixels of the image of the physical environment. In various implementations, the plurality of initial depths represents, for respective pixels of the image, an estimated distance between the image sensor and an object represented by the pixel.

The method 900 continues, in block 930, with the device generating a depth map for the image of the physical environment based on the plurality of initial depths and a respective plurality of confidences of the plurality of initial depths. In various implementations, the plurality of confidences represents, for respective ones of the initial depths, an estimated accuracy of the initial depth.

In various implementations, the plurality of initial depths includes multiple sets of initial depths from multiple sources, each source having a different spatial distribution (e.g., a different resolution, sparseness, or pattern) and a different average (or expected) confidence. For example, in various implementations, the plurality of initial depths includes a first set of 256 initial depths in a regular 16×16 grid from a LIDAR sensor, each with a relatively high confidence, and a second set of 400 initial depths randomly distributed based on stereo image matching, each with a relatively low confidence.

Thus, in various implementations, obtaining the plurality of initial depths (in block 920) includes receiving, from a first source, a first set of initial depths having a first resolution and receiving, from a second source, a second set of initial depths having a second resolution different than the first resolution. In various implementations, the first set of initial depths has a first average confidence and the second set of initial depths has a second average confidence different than the first average confidence. For example, in various implementations, the first source includes a laser depth sensor and the second source includes a stereo image sensor. Thus, in various implementations, the device obtains the second set of depths using stereo matching, e.g., using the image of the physical environment as captured by a left image sensor and another image of the physical environment captured by a right image sensor (or the left image sensor at a later time from a different perspective). In various implementations, the device obtains at least some of the plurality of depths through eye tracking, e.g., the intersection of the gaze directions of two eyes of user indicates the depth of an object the user is looking.

In various implementations, the plurality of initial depths corresponds to unmerged nodes of a quadtree. For example, in various implementations, a quadtree including a grid of nodes is defined, each node associated with a depth value, a subset of those depth values being the plurality of initial depths. A neighborhood of nodes of the quadtree are merged if (1) no nodes in the neighborhood have a depth value or (2) if depth values of the merged nodes can be reconstructed within a threshold via interpolation.

In various implementations, the depth map is a dense depth map which represents, for each pixel of the image of the physical environment, an estimated distance between the image sensor and an object represented by the pixel. In various implementations, the depth map includes a sparse depth map which represents, for each of a subset of the pixels of the image of the physical environment, an estimated distance between the image sensor and an object represented by the pixel.

In various implementations, the depth map includes updated depth values based on the plurality of initial depth values and the respective plurality of confidences. In various implementations, generating the depth map includes, for a particular element of the depth map corresponding to a particular pixel of the image of the physical environment: (1) determining a data-matching term based on a particular initial depth associated with the particular pixel of the image of the physical environment and a particular confidence of the particular initial depth, (2) determining a smoothness term based on a plurality of initial depths respectively associated with a neighborhood surrounding the particular pixel and a plurality of confidences of the plurality of initial depths respectively associated with the neighborhood surrounding the particular pixel, and (3) determining a weighted sum of the data-matching term and the smoothness term. For example, Equation (4) defines an energy function including a weighted sum of a data-matching term and a smoothness term.

In various implementations, a weight of the data-matching term in the weighted sum is based on a gaze of a user. For example, Equation (5) defines a weight of the data-matching term that is based on a gaze of a user.

In various implementations, generating the depth map includes, for the particular element of the depth map, determining an updated depth that maximizes the weighted sum. For example, Equation (6) defines an updated depth that maximizes the weighted sum of Equation (4a) or (4b).

In various implementations, the data-matching term is a Gaussian function of the updated depth. In various implementations, a height and/or width of the Gaussian function is dependent on the particular confidence of the particular initial depth. For example, Equation (8) defines a data-matching term as a Gaussian function of the updated depth with a height dependent on the particular confidence of the particular initial depth.

In various implementations, the neighborhood surrounding the particular pixel includes the particular pixel and the nearest pixel in each of four directions (e.g., up, down, left, and right). In various implementations, the neighborhood surrounding the particular pixel includes the particular pixel and pixels of the plurality of pixel within a threshold distance of the particular pixel.

In various implementations, the smoothness term is based on a weighted average of the plurality of initial depths respectively associated with a neighborhood surrounding the particular pixel. For example, Equation (11) is based on an interpolated (and clamped) depth based on the initial depths in the neighborhood.

In various implementations, a weighting of the weighted average is based on the plurality of confidences of the plurality of initial depths respectively associated with the neighborhood surrounding the particular pixel.

The method 900 continues, in block 940, with the device transforming, using the one or more processors, the image of the physical environment based on the depth map and a difference between a perspective of the image sensor and a perspective of a user. In various implementations, the device transforms the image of the physical environment at an image pixel level, an image tile level, or a combination thereof. In various implementations, the perspective of the image sensor is from a location of the image sensor and the perspective of the user is from a location of an eye of a user.

In various implementations, the device performs a projective transformation based on the depth map and the difference between the perspective of the image sensor and the perspective of the user.

In various implementations, the projective transformation is a forward mapping in which, for each pixel of the image of the physical environment at a pixel location in an untransformed space, a new pixel location is determined in a transformed space of the transformed image. In various implementations, the projective transformation is a backwards mapping in which, for each pixel of the transformed image at a pixel location in a transformed space, a source pixel location is determining in an untransformed space of the image of the physical environment.

In various implementations, the source pixel location is determined according to the following equation in which x_{cam} and y_{cam} are the pixel location in the untransformed space, x_{eye} and y_{eye} are the pixel location in the transformed space, P_{eye}e is a 4×4 view projection matrix of the user representing the perspective of the user, P_{cam} is a 4×4 view projection matrix of the image sensor representing the perspective of the image sensor, and d is the depth map value at the pixel location:

$$[ \begin{matrix}{x}_{c a m} \\ {y}_{c a m} \\ 1\end{matrix} ] ← {P}_{c a m} \cdot {P}_{e y e}^{- 1} \cdot [ \begin{matrix}{x}_{eye} \\ {y}_{eye} \\ 1 \\ ( \frac{1}{d} )\end{matrix} ] . \qquad ( 14 )$$

In various implementations, the source pixel location is determined using the above equation for each pixel in the image of the physical environment. In various implementations, the source pixel location is determined using the above equation for less than each pixel of the image of the physical environment.

In various implementations, the device determines the view projection matrix of the user and the view projection matrix of the image sensor during a calibration and stores data indicative of the view projection matrices (or their product) in a non-transitory memory. The product of the view projection matrices is a transformation matrix that represents a difference between the perspective of the image sensor and the perspective of the user.

Thus, in various implementations, transforming the image of the physical environment includes determining, for a plurality of pixels of the transformed image having respective pixel locations, a respective plurality of source pixel locations. In various implementations, determining the respective plurality of source pixel locations includes, for each of the plurality of pixels of the transformed image, multiplying a vector including the respective pixel location and the multiplicative inverse of the respective element of the depth map by a transformation matrix representing the difference between the perspective of the image sensor and the perspective of the user.

Using the source pixel locations in the untransformed space and the pixel values of the pixels of the image of the physical environment, the device generates pixel values for each pixel location of the transformed image using interpolation or other techniques.

In various implementations, the resulting transformed image includes holes. Such hole may be filled via interpolation or using additional image, such as another image from a different perspective (e.g., a second image sensor or the same image sensor at a different time).

The method 900 continues, in block 950, with the device displaying, on the display, the transformed image. In various implementations, the transformed image includes XR content. In some implementations, XR content is added to the image of the physical environment before the transformation (at block 940). In some implementations, XR content is added to the transformed image. In various implementations, the device determines whether to add the XR content to the image of the physical environment before or after the transformation based on metadata indicative of the XR content's attachment to the physical environment. In various implementations, the device determines whether to add the XR content to the image of the physical environment before or after the transformation based on an amount of XR content (e.g., a percentage of the image of the physical environment containing XR content).

In various implementations, the device determines whether to add the XR content to the image of the physical environment before or after the transformation based on metadata indicative of a depth of the XR content. Accordingly, in various implementations, the method 900 includes receiving XR content and XR content metadata, selecting the image of the physical environment or the transformed image based on the XR content metadata, and adding the XR content to the selection.

While various aspects of implementations within the scope of the appended claims are described above, it should be apparent that the various features of implementations described above may be embodied in a wide variety of forms and that any specific structure and/or function described above is merely illustrative. Based on the present disclosure one skilled in the art should appreciate that an aspect described herein may be implemented independently of any other aspects and that two or more of these aspects may be combined in various ways. For example, an apparatus may be implemented and/or a method may be practiced using any number of the aspects set forth herein. In addition, such an apparatus may be implemented and/or such a method may be practiced using other structure and/or functionality in addition to or other than one or more of the aspects set forth herein.

It will also be understood that, although the terms “first,” “second,” etc. may be used herein to describe various elements, these elements should not be limited by these terms. These terms are only used to distinguish one element from another. For example, a first node could be termed a second node, and, similarly, a second node could be termed a first node, which changing the meaning of the description, so long as all occurrences of the “first node” are renamed consistently and all occurrences of the “second node” are renamed consistently. The first node and the second node are both nodes, but they are not the same node.

The terminology used herein is for the purpose of describing particular implementations only and is not intended to be limiting of the claims. As used in the description of the implementations and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

1-19. (canceled)

20. A method comprising:
at a device having an image sensor, a display, one or more processors, and non-transitory memory;
capturing, using the image sensor, an image of a physical environment;
obtaining a plurality of initial depths respectively associated with a plurality of pixels of the image of the physical environment;
generating a depth map for the image of the physical environment based on the plurality of initial depths and a respective plurality of confidences of the plurality of initial depths;
transforming, using the one or more processors, the image of the physical environment based on the depth map and a difference between a perspective of the image sensor and a perspective of a user; and
displaying, on the display, the transformed image.

21. The method of claim 20, wherein obtaining the plurality of initial depths includes receiving, from a first source, a first set of initial depths having a first spatial distribution and receiving, from a second source, a second set of initial depths having a second spatial distribution different than the first spatial distribution.

22. The method of claim 21, wherein the first set of initial depths has a first average confidence and the second set of initial depths has a second average confidence.

23. The method of claim 21, wherein the first source includes a laser depth sensor and the second source includes a stereo image sensor.

24. The method of claim 20, wherein the plurality of initial depths corresponds to unmerged nodes of a quadtree.

25. The method of claim 24, wherein a neighborhood of nodes of the quadtree are merged if no nodes in the neighborhood have a depth value or if depth values of merged nodes can be reconstructed within a threshold via interpolation.

26. The method of claim 20, wherein generating the depth map includes, for a particular element of the depth map corresponding to a particular pixel of the image of the physical environment:
determining a data-matching term based on a particular initial depth associated with the particular pixel of the image of the physical environment and a particular confidence of the particular initial depth;
determining a smoothness term based on a plurality of initial depths respectively associated with a neighborhood surrounding the particular pixel and a plurality of confidences of the plurality of initial depths respectively associated with the neighborhood surrounding the particular pixel; and
determining a weighted sum of the data-matching term and the smoothness term.

27. The method of claim 26, wherein a weight of data-matching term in the weighted sum is based on a gaze of the user.

28. The method of claim 26, wherein generating the depth map includes, for the particular element of the depth map, determining an updated depth that maximizes the weighted sum.

29. The method of claim 28, wherein the data-matching term is a Gaussian function of the updated depth.

30. The method of claim 29, wherein a height and/or a width of the Gaussian function is dependent on the particular confidence of the particular initial depth.

31. The method of claim 26, wherein the neighborhood surrounding the particular pixel includes the particular pixel and the nearest pixel in each of four directions.

32. The method of claim 26, wherein the smoothness term is based on a weighted average of the plurality of initial depths respectively associated with a neighborhood surrounding the particular pixel.

33. The method of claim 32, wherein a weighting of the weighted average is based on the plurality of confidences of the plurality of initial depths respectively associated with the neighborhood surrounding the particular pixel.

34. A device comprising:
an image sensor;
a display;
a non-transitory memory; and
one or more processors to:
capture, using the image sensor, an image of a physical environment;
obtain a plurality of initial depths respectively associated with a plurality of pixels of the image of the physical environment;
generate a depth map for the image of the physical environment based on the plurality of initial depths and a respective plurality of confidences of the plurality of initial depths;
transform, using the one or more processors, the image of the physical environment based on the depth map and a difference between a perspective of the image sensor and a perspective of a user; and
display, on the display, the transformed image.

35. The device of claim 34, wherein the device is a head-mounted device (HMD), the image sensor is a forward-facing image sensor, the perspective of the image sensor is from a location of the image sensor, and the perspective of the user is from a location of an eye of a user of the HMD.

36. The device of claim 34, wherein the one or more processors are to generate the depth map by, for a particular element of the depth map corresponding to a particular pixel of the image of the physical environment:
determining a data-matching term based on a particular initial depth associated with the particular pixel of the image of the physical environment and a particular confidence of the particular initial depth;
determining a smoothness term based on a plurality of initial depths respectively associated with a neighborhood surrounding the particular pixel and a plurality of confidences of the plurality of initial depths respectively associated with the neighborhood surrounding the particular pixel; and
determining a weighted sum of the data-matching term and the smoothness term.

37. The device of claim 36, wherein the smoothness term is based on a weighted average of the plurality of initial depths respectively associated with a neighborhood surrounding the particular pixel.

38. The device of claim 37, wherein a weighting of the weighted average is based on the plurality of confidences of the plurality of initial depths respectively associated with the neighborhood surrounding the particular pixel.

39. A non-transitory memory storing one or more programs, which, when executed by one or more processors of a device with an image sensor and a display, cause the device to:
capture, using the image sensor, an image of a physical environment;
obtain a plurality of initial depths respectively associated with a plurality of pixels of the image of the physical environment;
generate a depth map for the image of the physical environment based on the plurality of initial depths and a respective plurality of confidences of the plurality of initial depths;
transform, using the one or more processors, the image of the physical environment based on the depth map and a difference between a perspective of the image sensor and a perspective of a user; and
display, on the display, the transformed image.
